(19) United States
(12) Patent Application Publication
(10) Pub. No.: US 2015/0294774 A1
(43) Pub. Date: Oct. 15, 2015

(54) PRODUCTION METHOD FOR HIGH-PERMEABILITY GRAIN-ORIENTED ELECTRICAL STEEL

(71) Applicant: Mikhail B Zirlin, Moscow (RU)

(72) Inventor: Mikhail B Zirlin, Moscow (RU)

(21) Appl. No.: 14/281,854

(22) Filed: May 19, 2014

(30) Foreign Application Priority Data
Apr. 14, 2014 (EP) 14164576.2

(51) Int. Cl. H01F 1/147; C21D 8/12

(52) U.S. Cl. CPC H01F 1/14775; C21D 8/1205; C21D 8/1222; C21D 8/1261; C22C 38/16

(57) ABSTRACT

The invention refers to ferrous metallurgy, in particular, to production of grain-oriented electrical steel deployed in a manufacture of power transformer cores. Ensuring high magnetic permeability of steel and homogeneity of the magnetic properties requires slab casting, slab heating, rough and finishing hot rolling, cooling, pickling, double cold rolling with an intermediary decarburizing annealing, MgO coating application, box annealing and flattening annealing after rolling strips are cooled within the time not exceeding two seconds, the heating for the high-temperature annealing in the temperature range of 400-700° C. is carried out at the rate of 20-25° C./hour.

### RELATED APPLICATIONS

This application claims priority to European patent application serial number 14164576.0 filed on Apr. 14, 2014 and incorporated herewith by reference in its entirety.

### BACKGROUND OF THE INVENTION

The invention refers to ferrous metallurgy and can be used while producing grain-oriented electrical steel deployed in a manufacture of power transformer cores.

Subject to a purpose of transformers, grain-oriented steel is subdivided into steel having restricted (B₈<1.85 T), elevated (B₈=1.86-1.89 T) and high (B₈=1.90-1.95 T) permeability (B₈—Induction-magnetic flux density, tesla; 8—Intensity of a field, a/cm). The first group is employed for producing distribution transformers. The second one—partially for distribution transformers and partially for power ones, and the third group is mainly used in power distribution industry. A share of the third group metal is estimated as 35-45% with a possible upcoming increase up to 45-50%.

Steel's magnetic properties and, in particular, induction B8, is considerably defined by a degree of sophistication of the Goss texture ({110}<001>) formed during the secondary recrystallization ({110}<001>—texture, {110}—plane, <001>—direction, relatively direction of deformation). The first group metal is characterized by the average deviation of Goss grains from the perfect orientation by of 7-8 deg., the second group—by a 4-6 degree deviation and the third group—by a 3-4 degree deviation.

Formation of the prefect texture requires compliance with the following basic conditions:

Formation in the primary recrystallization matrix of the texture expressed by the octahedral component ({111}<112>) (absorbed component) and sharp Goss grains (absorbing component), whose intensity is restricted;
restricting the grain growth at stages preceding the secondary recrystallization, which is implemented by managing the impurity system as dissolved surfactants and nonmetallic inclusions.

Steel with restricted permeability, whose share for the last decade has dropped from 65 to 20%, is produced under the sulfide inhibiting method with the double cold rolling and recrystallization annealing in an intermediate thickness [1].

Steel of elevated permeability is also produced under a double cold rolling technique. An option of Kawasaki Company (at present, JFE) provides for an improvement of properties due to sharpening of Goss component in the subsurface area of hot-rolled coils [2], which is then reproduced in the finished material under the texture inheritance mechanism [3]. However, due to insufficient intensity of the octahedral texture the magnetic induction B8 is limited by 1.86-1.89 T. Much the same induction level B8 is typical of nitride inhibited steel [4] practiced in Russia, China and Eastern Europe countries, with the technology being characterized by a sufficient intensity of the absorbed texture. In the meantime, a more dispersed Goss component of the hot-rolled material texture prevents from increasing B8 up to 1.90 T and more.

Currently, high permeability steel is produced under two production routes developed by Nippon Steel. The general condition for these technologies is a single cold rolling with a high deformation thus providing for both an expansion of the octahedral component and sharpening of the Goss component. The difference of these routes is a method of managing impurity systems. The first classical technology [5,6] practiced from the beginning of 1970s provides for a formation of the required impurity system during hot rolling, but the second one introduced in the middle of 1990s [7,8] is based on feeding the key modifying element, i.e. nitrogen during chemical and heat processing in the final thickness.

The basic disadvantage of the first route is a necessity of high-temperature slab heating accompanied by an abundant slag formation, whose removal is quite labor-intensive and requires additional material expenses.

First and foremost, the second route significantly restricts a throughput of decarburizing annealing furnaces, and, secondly, provides for usage of the environmentally unfriendly ammonia technology.

Disadvantages of both technologies include:
Necessity of introducing into the processing cycle a high-temperature (T-1150° C.) heat treatment of hot-rolled coils;
Excess consumption of material (by 10-13%), energy (by 20-25%) and manpower (by 15-20%) resources.

A challenge of the assumed invention is a development of a new technology of high permeability grain-oriented steel production free of the above-mentioned drawbacks, which is based on a combination of merits of technological routes practiced by the Japanese company Kawasaki (JFE) and Russian company NLMK.

### SUMMARY OF THE INVENTION

The invention refers to ferrous metallurgy, in particular, to production of grain-oriented electrical steel deployed in a manufacture of power transformer cores. Ensuring high magnetic permeability of steel and homogeneity of the magnetic properties requires slab casting, slab heating, rough and finishing hot rolling, cooling, pickling, double cold rolling with an intermediary decarburizing annealing, MgO coating application, box annealing and flattening annealing distinctive in that the steelmaking is implemented at the following ratio of the components, % wt: C=0.018-0.035; Mn=0.15-0.40; Si=3.15-3.50; Al=0.010-0.035; N₂=0.0090.015; Cu=0.4-0.6 with the balance of Fe and unavoidable impurities, at the carbon-silicon concentration chosen so that during the finishing hot rolling within the range of 1130-1280° C. the austenite ratio comes to 2-10%, and with the rolling at the total deformation ratio of 80-95% and the rolling end temperature of 950-1030° C. After rolling strips are cooled within the time not exceeding two seconds, but the heating for the high-temperature annealing in the temperature range of 400-700° C. is carried out at the rate of 20-25° C./hour.

### DESCRIPTION OF THE DRAWINGS

FIG. 1 illustrates a schematic view of HGO production by classic technology with MnS-AIN inhibition;

FIG. 2 illustrates a schematic view of HGO production by nitriding technology; and

FIG. 3 illustrates a schematic view of novel HGO production of the present invention.

### DETAILED DESCRIPTION OF THE INVENTION

The technical result of the invention is to ensure high magnetic permeability of steel.

To achieve the above-stated technical result the production process for high permeability grain-oriented electrical steel, which includes steelmaking, slab casting, slab heating, rough and finishing hot rolling, cooling, pickling, double cold rolling with intermediary decarburizing annealing, MgO coating application, box annealing and flattening annealing comprises steelmaking at the following mixture ratio, % wt: C 0.018-0.035, Mn 0.10-0.40, Si 3.0-3.50, Al 0.01-0.035, N₂ 0.008-0.015, Cu 0.4-0.6, with the balance of Fe and unavoidable impurities, at carbon-silicon ratio chosen so that the austenite fraction during the finishing hot rolling within the range of 1150-1050° C. comes to 2-10%, at that, before the finishing cold rolling the breakdown bar temperature is maintained in the range of 1130-1280° C. (preferably 1180-1240° C.) and the rolling is carried out at an overall deformation ratio of 80-95% and the rolling end temperature of 950-1030° C. (preferably 970-1030° C.). After rolling the strips are subject to cooling within time not exceeding two seconds, but heating for the high-temperature annealing is carried out within the temperature range of 400-700° C. at the rate of 15-30° C./hour (preferably 20-25° C./hour). Reaching the required temperature before the finishing rolling requires either breakdown bars being heated in open-flame or induction furnaces or being cast in compact strip production lines.

The above-mentioned technology conceptually differs from the operating ones in terms of reaching high permeability under a double cold rolling technique. Efficiency of the proposed technology is a remarkable decrease of expenses per production stage along with an exclusion of time-consuming and environmentally unfriendly operations (high-temperature slab heating, nitriding and others) from the processing cycle.

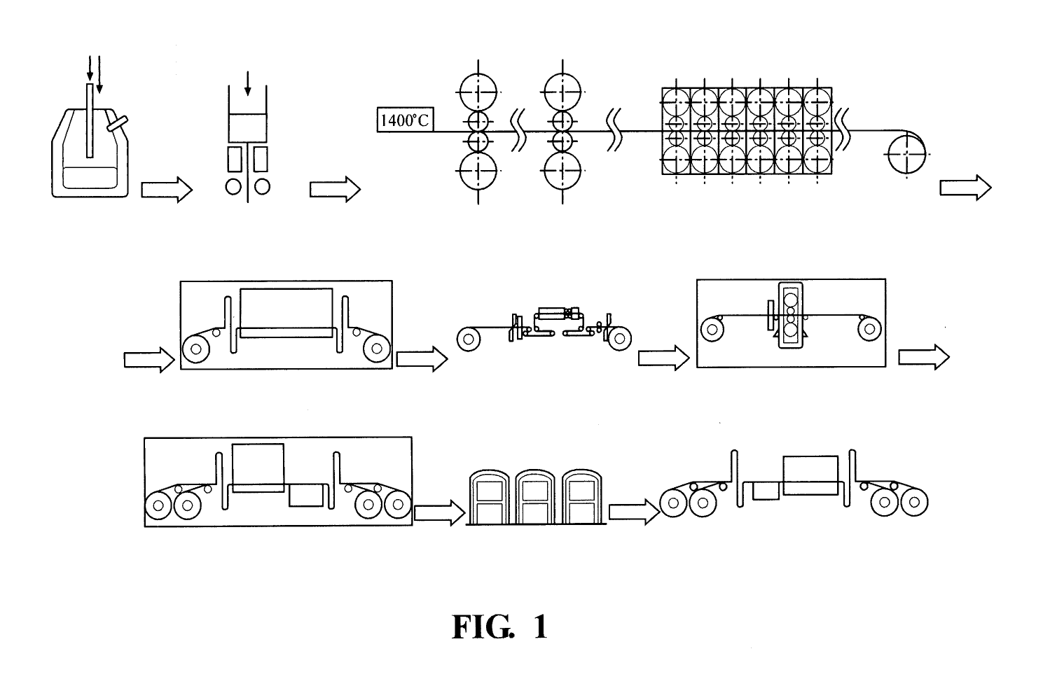

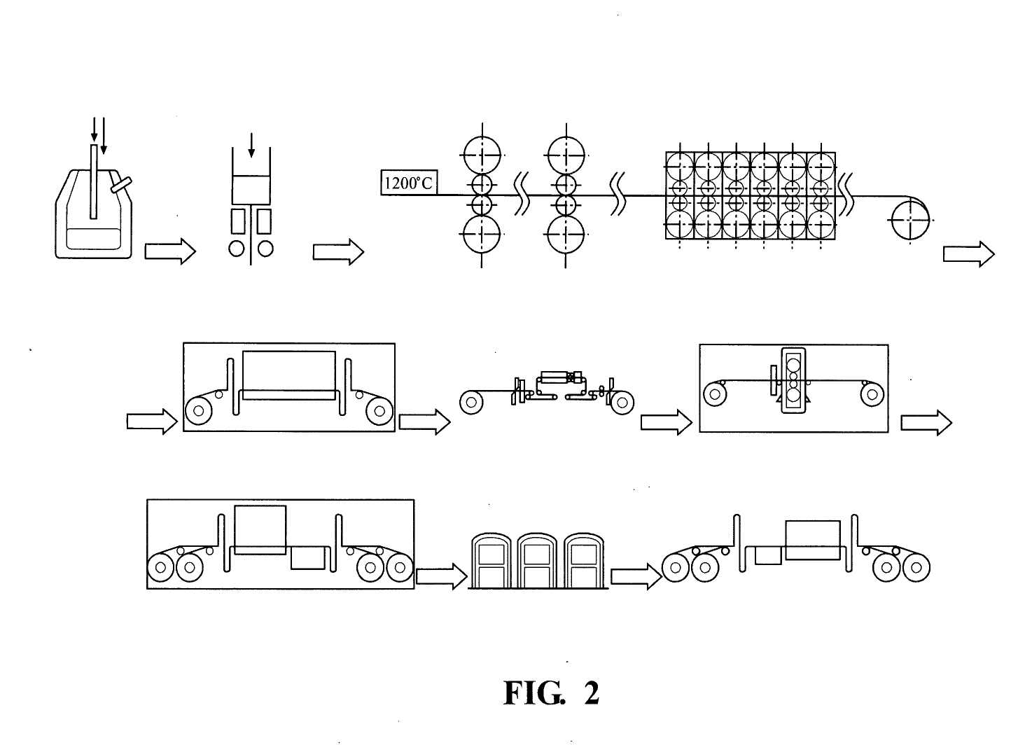

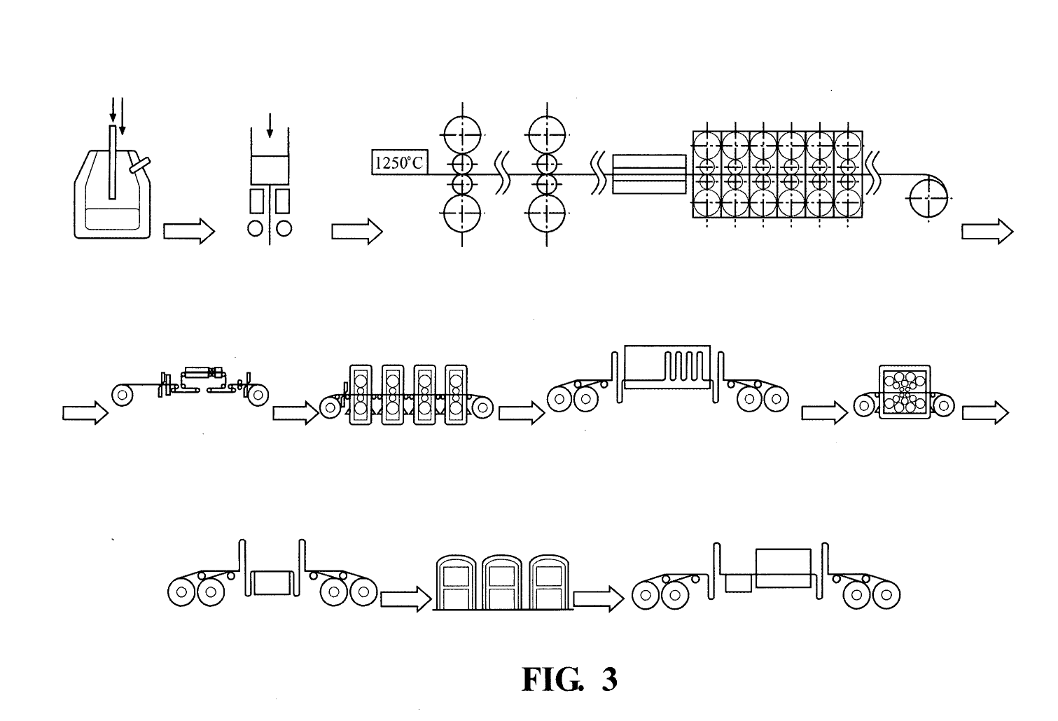

Differences between acknowledged [5-8] and proposed technologies of high permeability steel production arise from scheme comparison in FIG. 1-3.

Maintaining the structure and texture of hot-rolled coils typical of the deformed condition (at minimal recrystallization development), at which the subsurface layer ( 1/10- 1/7 over thickness) is noted for a formation of the sharp Goss textured area obtained by:
Increasing the deformation temperature in the finishing train up to (950-1030° C.), at which the dynamic recovery restrains a possibility of recrystallization;
Minimizing an extent of the phase recrystallization, which also restrains a possibility of recrystallization;
Time limit between the rolling termination and forced cooling of hot-rolled strips.

Temperature rise for the rolling end is possible by means of:
increasing slab heating temperature and thickness of the intermediary breakdown bars;
increasing the rolling speed;
high-temperature slab heating or heating breakdown bars before the finishing rolling;
producing hot-rolled coils in compact strip production lines.

Decrease of the phase recrystallization is obtained as a result of the rational choice of the carbon-silicon concentration ratio.

A conspicuous octahedral texture in the primary recrystallization matrix is obtained as a result of:
excluding a high-speed heating of cold-rolled strips in a final thickness;
restricting metal heating rate during the high-temperature annealing (15-30° C./hour) in the range of recovery and recrystallization temperatures (400-700° C.) [9];
keeping a part of nitrogen as solids up to the softening stage at box annealing;
copper-assisted metal modification (0.4-0.6%).

Nitrogen and copper precipitating from the supersaturated solution at the polygonization stage contribute to increasing the primary recrystallization temperature and provide for more than double strengthening of the octahedral component in the primary recrystallization matrix.

Thus, the assumed technology includes the following operations as the key ones:
1. Metal smelting of the following composition, %: C=0.018-0.035; Mn=0.15-0.40; Si=3.15-3.50; Al=0.012-0.030; N₂=0.009-0.015; Cu=0.4-0.6; with the balance of Fe and unavoidable impurities;
2. Continuous slab casting including thin slabs in the compact strip production lines;
3. Hot rolling to thickness of 1.5-3.5 mm with the deformation ending at 950-1030° C. and forced cooling of strips in less than two seconds after the deformation is over;
4. Cold rolling to an intermediary thickness of 0.55-0.90 mm;
5. Decarburizing annealing in the humidified nitrogen-hydrogen mixture;
6. Cold rolling to thickness of 0.15-0.35 mm;
7. Applying a heat-resistant coating;
8. High-temperature annealing with a restriction of coil heating in the range of 400-700° C. up to 15-30° C./hour;
9. Flattening annealing with application of the insulation coating.

### EXAMPLES OF THE INVENTION EMBODIMENT

### Example 1

Steelmaking with the following chemical composition, % wt: C (0.018-0.035), Mn (0.1-0.4), Si (3.0-3.5), Al (0.01-0.03), N₂ (0.08-0.015), Cu (0.4-0.6) with the balance of Fe and unavoidable impurities. Steel was poured in the continuous casting machines to obtain slabs of 220 mm thick. Slabs were heated in push furnaces and rolled in the rough mill to breakdown bars of 30-40 mm thick. Temperature of the rolling end came to 1200-1220° C.

Breakdown bars were heated in a tunnel open-flame furnace. After descale sprays the temperature of breakdown bars came to 1210-1240° C. with a subsequent finishing rolling to the strip of 2.5 mm thick.

The temperature of the finishing rolling end was changed in the range of 930-1030° C. by changing the deformation speed and thickness of the intermediate breakdown bars. Subsequent stages included pickling, first cold rolling for 0.65 mm, decarburizing annealing, second cold rolling for 0.30 mm, MgO coating application, box annealing with the speed limit for coil heating within the range of 400-700° C. up to 15-30° C./hour, flattening annealing with an application of the insulation coating. Table 1 contains data defining an influence of the hot rolling termination temperature on steel's magnetic properties.

TABLE 1
Influence of the rolling end temperature
on steel's magnetic properties.

| | | |
|---|---|---|
| Sequence | Rolling end | Magnetic properties |

| No. | temperature, ° C. | P_{1, 7/50}, W/kg | B₈₀₀, T |
|---|---|---|---|
| 1 | 900 | 1.23 | 1.85 |
| 2 | 930 | 1.20 | 1.86 |
| 3 | 960 | 1.12 | 1.88 |
| 4 | 978 | 1.03 | 1.91 |
| 5 | 990 | 1.00 | 1.91 |
| 6 | 1003 | 1.02 | 1.90 |
| 7 | 1010 | 1.00 | 1.91 |
| 8 | 1030 | 1.02 | 1.91 |

P_{1, 7/50} - cose loss, 1/7 - induction 1, 7 T; 50 - Frequency 50 Hertz

These data mean that an increase of the rolling temperature permits reaching a level of the magnetic properties typical of high permeability steel, which is explained by suppression of the recrystallization processes at a hot deformation by means of both softening under the dynamic recovery mechanism and as a result of restraining the phase recrystallization defined by the efficient ratio of the ferrite-promoting [Si] and austenite-promoting [C] elements.

### Example 2

Steelmaking with the following chemical composition, % wt: C (0.025-0.041), Mn (0.15-0.25), Si (3.15-3.17), Al (0.016-0.018), N₂ (0.009-0.011), Cu (0.4-0.6), with the balance of Fe and unavoidable impurities. Steel was poured in the continuous casting machines to obtain slabs of 220 mm thick.

Slabs were heated in walking-beam furnace and rolled in the rough mill to breakdown bars of 50 mm thick. The rolling end temperature came to 1210-1230° C.

Breakdown bars were heated in an open-flame furnace up to 1230-1250° C. After descale sprays the temperature of breakdown bars came to 1180-1200° C. Breakdown bars were deformed in the finishing train to strips of 2.2 mm thick. The rolling end temperature was maintained in the range of 990-1010° C.

The subsequent metal processing corresponded to that one described in the Example 1. Intermediate thickness was 0.60 mm, final one-0.30 mm. Table 2 shows the results obtained.

TABLE 2
Influence of the chemical and phase composition
on the magnetic properties.

| Concentration of | | | | |
|---|---|---|---|---|
| elements defining the | | Austenite fraction | Magnetic properties | |
| phase composition, % | | at temperature | P_{1, 7/50}, | B₈₀₀, |
| C | Si | 1150-1050° C., %* | W/kg | T |
| 0.012 | 3.15 | 0 | 1.88 | 1.73 |
| 0.015 | 3.15 | 1 | 1.35 | 1.80 |
| 0.020 | 3.15 | 3 | 1.07 | 1.91 |
| 0.024 | 3.17 | 7 | 1.02 | 1.93 |
| 0.028 | 3.17 | 9 | 1.05 | 1.90 |
| 0.030 | 3.17 | 11 | 1.07 | 1.89 |
| 0.035 | 3.17 | 15 | 1.12 | 1.87 |
| 0.041 | 3.17 | 22 | 1.19 | 1.86 |

*calculated as per diagram Fe—Si—C according to the formula Vγ = 694[C] − 23 [Si] + 64.8; where: Vγ—austenite fraction [C] and [Si]—carbon-silicon weight concentration.

Data of the Table 2 imply the following:
At typical silicon content (basic ferrite-promoting element) the best magnetic properties complying with the requirements to high permeability steel are obtained at carbon concentration within 0.020-0.028%;
at carbon concentration 0.018% and less, the secondary recrystallization fails to be completely realized owing to AIN precipitation at early stages of hot rolling;
at elevated carbon concentration (>0.030%) magnetic properties gradually deteriorate due to the texture degradation in surface layers of hot-rolled coils caused by the phase recrystallization. Increasing a carbon fraction to over 0.030% is possible and, probably, desirable at an equivalent silicon concentration so that during the finishing hot rolling in the temperature range of 1100-1150° C. to maintain the austenite ratio within 2-10%.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. (canceled)

2. (canceled)

3. (canceled)

4. (canceled)

5. A production method for high permeability grain-oriented electrical steel including steelmaking, slab casting, slab heating, rough and finishing hot rolling, cooling, pickling, double cold rolling with an intermediary decarburizing annealing, MgO coating application, box annealing and flattening annealing, the production method including the step of:
implementing the steelmaking process at the following ratio of components, % of 100% of wt: C=0.018%-0.035%; Mn=0.15%-0.40%; Si=3.15%-3.50%; Al=0.010%-0.035%; N₂=0.009%-0.015%; Cu=0.4%-0.6% with the balance of Fe and unavoidable impurities; at that the carbon-silicon ratio is chosen so that during the finishing hot rolling the austenite ratio comes to 2-10%; the temperature of the hot rolling start and end is maintained within 1130-1280° C. and 950-1030° C. respectively; and
cooling of as-rolled strips begins in not more than two seconds, wherein the double cold rolling is further defined by cold rolling to an intermediary thickness of 0.55-0.90 mm and then to a second cold rolling to thickness of 0.15-0.35 mm whereby decarburizing annealing in the humidified nitrogen-hydrogen mixture is performed between the cold rolling to an intermediary thickness of 0.55-0.90 mm and the second cold rolling to thickness of 0.15-0.35 mm, whereby MgO coating is performed after the second cold rolling to thickness of 0.15-0.35 mm, to ensure high magnetic permeability of steel thereby decreasing expenses per production stage along with an exclusion of time-consuming and high-temperature slab heating and nitriding from the processing cycle.

6. The production method as set forth in claim 5, including the step of heating box annealing coils at a rate of 15-30° C./hour within the temperature range of 400-700° C.

7. The production method as set forth in claim 5, including the step of implementing thin slab casting and rolling in compact strip production lines.

8. The production method as set forth in claim 5, including the step of heating breakdown bars in open-flame or induction furnaces before rolling in a finishing train.
